(19) United States
(12) Patent Application Publication
(10) Pub. No.: US 2005/0072422 A1
(43) Pub. Date: Apr. 7, 2005

(54) Pressurized drinking system

(76) Inventors: Leslie A. Wolfe, Goldvein, VA (US); Paul J. Biermann, Columbia, MD (US)

Correspondence Address: APPLIED PHYSICS LABORATORY;THE JOHNS HOPKINS UNIVERSITY, OFFICE OF PATENT COUNSEL, 11100 JOHNS HOPKINS ROAD, LAUREL, MD, 20723-6099, US

(21) Appl. No.: 10/941,572

(22) Filed: Sep. 15, 2004

Related U.S. Application Data
(60) Provisional application No. 60/503,670, filed on Sep. 17, 2003.

(51) Int. Cl. A62B 7/00

(52) U.S. Cl. 128/202.15

(57) ABSTRACT

A pressurized fluid delivery system is disclosed. The system includes a container with an outer bag and an inner bag. The inner bag can contain a consumable fluid. The inner bag includes a fluid port capable of transferring the fluid through a tube and to a pendant that is designed to engage a mask connector. The outer bag can contain both the inner bag and a pressure space. Increasing pressure to the pressure space helps to squeeze fluid out of the inner bag and deliver the fluid to a user. The pendant can also include a gas port that can be used to deliver a gas to the user.

### CROSS REFERENCE TO RELATED APPLICATIONS

This application claims the benefit of U.S. Provisional Patent Application No. 60/503,670, filed on Sep. 17, 2003. This Provisional Patent Application is hereby incorporated by reference in their entirety.

### BACKGROUND OF THE INVENTION

1. Field of the Invention

This invention relates to a system that provides fluid communication into chemical protective equipment, and more particularly, to pressurized drinking system.

2. Related Art

In order to protect soldiers and other personnel in theaters of combat where there is a potential threat of exposure to nuclear, biological or chemical (NBC) materials, the military sometimes provides chemical protective equipment (CPE). In these kinds of environments, military personnel are trained and equipped to resist contamination or exposure to harmful or toxic substances. Generally, this requires the use of protective gear, protective clothing or Mission Oriented Protective Posture (MOPP) equipment.

Use of MOPP gear is restrictive, uncomfortable and cumbersome. It is difficult at best to keep properly hydrated and impossible to eat while donning MOPP. Under normal conditions the user must go through a lengthy process just to drink water. Potash (U.S. Pat. No. 3,731,717) discloses a conventional canteen that has been adapted for use with a protective mask. This system is known to be awkward and difficult to use. The user must perform the following steps just to drink water. The canteen must first be removed from the canteen carrier, the drinking tube must be located on the front of the mask and extended for insertion into the canteen top. Once the mask tube is inserted in to the canteen top, the canteen must them be held at or above the head, after which the user can suck water out of the canteen.

This process alone makes simple maintenance hydration laborious and often discourages the user from drinking. The can contribute to heat disorder injury related to the use of MOPP gear. Additionally, the act of plugging the mask tube into the top of the canteen exposes the user to contaminants that may enter the tube or canteen. Also, in combat situations, where hydration is required more frequently because of the higher levels of exertion, the actions required to use the current system exposes the user to a high risk of lethal injury.

Various other drinking systems have been proposed for a variety of different purposes. These different systems use a variety of different techniques to provide drinking water to a user.

Schneider (U.S. Pat. No. 4,505,310) discloses a liquid storage and delivery system adapted for use with a protective mask. The Schneider device uses an in-line, hand operated siphon bulb pump to assist in fluid transfer. Schneider (U.S. Pat. No. 4,712,594) is a ganged version of the Schneider '310 patent.

Seekins (U.S. Pat. No. 4,971,048) teaches a system using a pair a parallel flow paths and valves to control the direction of flow. This system allows a user to blow into the canteen while drawing liquid from a container.

Holmes (U.S. Pat. No. 5,358,142) teaches a mouth pressurized system. However, blowing into a container is not practical for NBC environments.

Swank (U.S. Pat. No. 6,666,360) teaches a system that maintains tension against a user's body and automatically fills a squeeze bottle.

While the related art generally teaches drinking systems, none of the references teach a system for use in a potentially NBC environment that is convenient, easy to use, and can provide continuous and automatic hydration to a user. The systems disclosed in the related art require significant amounts of user participation and work to draw fluid. Also, the related art fails to teach a gas delivery system in combination with a fluid delivery system.

### SUMMARY OF THE INVENTION

In one aspect, the invention provides a system for transferring fluid into chemical protective equipment comprising: a container comprising an outer bag and an inner bag, the inner bag containing a consumable fluid, and including a fluid port capable of transferring fluid from the inner bag; a tube connected to the fluid port at a first end and connected to a pendant at a second end; the pendant configured to engage a mask connector; the outer bag substantially surrounding the inner bag; a pressure space being defined between the outer bag and the inner bag; the pressure space having a pressure port in flow communication with a pressure source, the pressure source capable of increasing a pressure in the pressure space; and wherein increasing pressure in the pressure space causes fluid contained in the inner bag to flow out of the fluid port.

In another aspect, the invention provides an integral pressure line that places the pressure space in fluid communication with the pressure port.

In another aspect, the invention provides a seal between the inner bag and the outer bag.

In another aspect, the invention provides a seal that joins the inner bag to the outer bag.

In another aspect, the invention provides a pressure release mechanism.

In another aspect, the invention provides a fluid port and a pressure port that include a dual quick disconnect assembly.

In another aspect, an increase in volume of the pressure space causes a decrease in volume of the inner bag.

In another aspect, the invention provides a system for delivering a fluid and gas comprising: a container including a fluid chamber and a pressure space; the fluid chamber including a fluid port in flow communication with the fluid chamber; a tube having a first end connected to the fluid port and a second end connected to a pendant; the pendant having a first portion configured to engage a mask connector; the pendant also having a gas port configured to receive gas.

In another aspect, the gas port is disposed on a central portion of the pendant.

In another aspect, the gas port is disposed on a rearward portion of the pendant, proximate the tube.

In another aspect, fluid is capable of passing through the pendant and the gas port interrupts fluid flow through the pendant.

In another aspect, the gas includes oxygen.

In another aspect, the gas includes a gas infused with a pharmaceutical compound.

In another aspect, the gas is delivered to a user through a mask connector and a mask tube.

In another aspect, the invention provides a system for transferring fluid into chemical protective equipment comprising: a container comprising an outer bag and an inner bag, the inner bag containing a consumable fluid, and including a fluid port capable of transferring fluid from the inner bag; a tube connected to the fluid port at a first end and connected to a pendant at a second end; the pendant configured to engage a mask connector and having a gas port configured to receive gas; a pressure space being defined between an outer bag and the inner bag; the pressure space having a pressure port in flow communication with a pressure source, and wherein increasing pressure in the pressure space causes a reduction in volume of the inner bag.

In another aspect, fluid is capable of passing through the pendant and the gas port interrupts fluid flow through the pendant.

In another aspect, the container includes a seal between the inner bag and the outer bag.

In another aspect, the seal joins the inner bag to the outer bag.

In another aspect, the bottom portion of the inner bag becomes inverted as additional pressure is applied to the pressure space.

In another aspect, the container includes an integral pressure line that places the pressure space in fluid communication with the pressure port.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a preferred embodiment of chemical protective equipment.

FIG. 2 is a schematic diagram of a preferred embodiment of a pressurized drinking system.

FIG. 3 is an enlarged schematic diagram of a preferred embodiment of a pendant.

FIG. 4 is an exploded schematic diagram of a preferred embodiment of a soft canteen and attachment device.

FIG. 5 is a schematic diagram of a preferred embodiment of a soft canteen.

FIG. 6 is a schematic diagram of a preferred embodiment of a soft canteen.

### DETAILED DESCRIPTION OF THE PREFERRED EMBODIMENT(S)

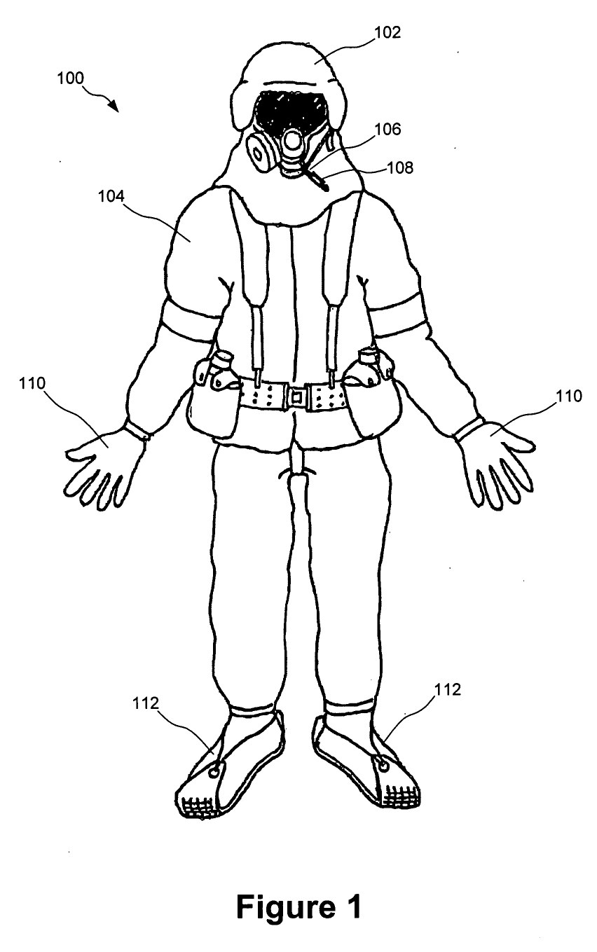

MOPP equipment can include CPE, an embodiment of which is shown in FIG. 1. In the embodiment shown in FIG. 1, CPE 100 includes mask 102, overgarment 104, which can be made of a thick, charcoal impregnated material, heavy rubber over-boots 112, and heavy rubber gloves 110. Mask 102 includes an integrated mask tube 106 and a mask connector 108. In the embodiment shown in FIG. 1, a first end of mask tube 106 is attached to mask 102 and mask connector 108 is attached to a second end of mask tube 106.

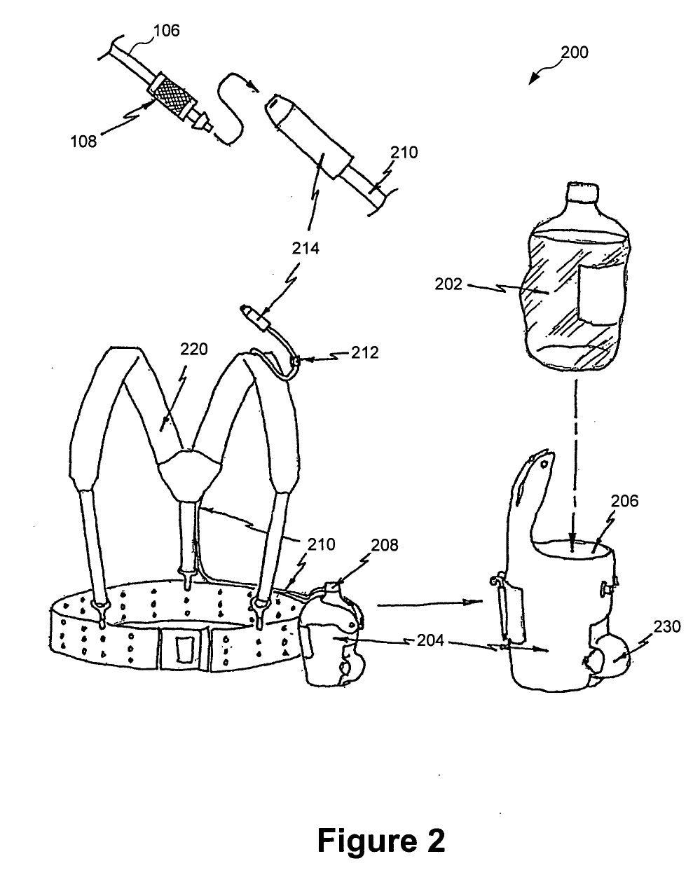

Referring to FIG. 2, a pressurized drinking system (PDS) 200 can be used with CPE 100. PDS 200 includes soft canteen 202 and carrier 204. Preferably carrier 204 includes a retaining portion 206 that is designed to retain and hold canteen 202. In some embodiments, carrier 204 is designed to engage Load Bearing Equipment (LBE) 220. Other devices, besides carrier 204, can also be carried by LBE 220.

Once soft canteen 202 is associated with carrier 204 and carrier 204 is attached to LBE 220, tube 210 associated with LBE 220 is attached to soft canteen 202. Preferably, attachment device 208 is used to associate a first end 222 of tube 210 to soft canteen 202. Tube 210 is preferably attached to LBE 220 as shown in FIG. 2, and a second end 224 of tube 210 includes pendant 210.

Pendant 210 is configured to engage mask connector 108. Preferably, pendant 210 is capable of making an air tight and water tight seal with mask connector 108 that also prevents the entry of NBC materials.

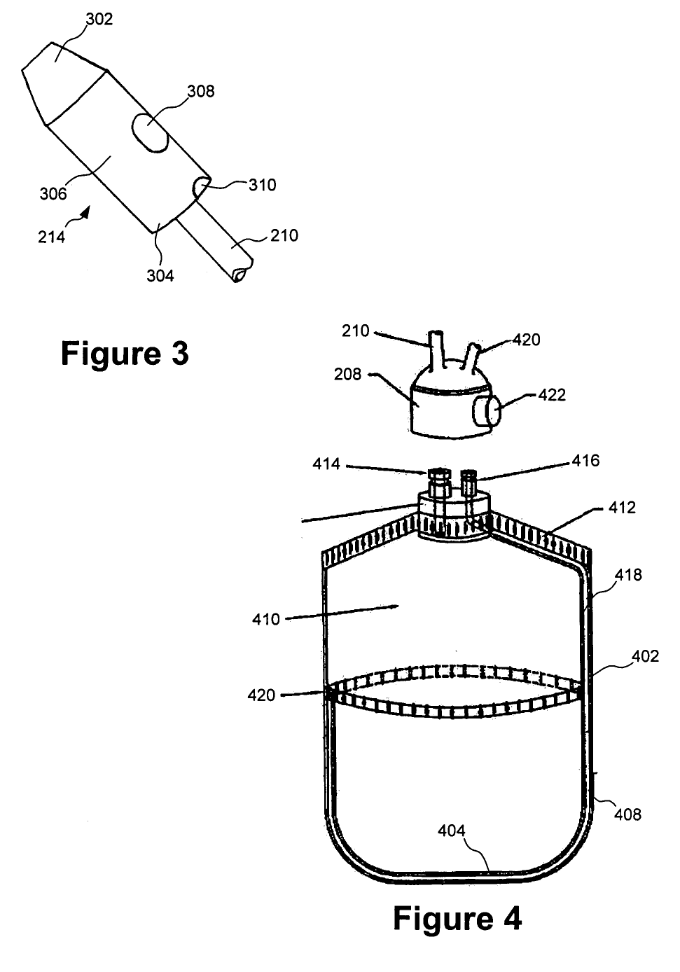

FIG. 3 is an enlarged schematic view of pendant 210. Forward portion 302 of pendant 214 preferably includes provisions to engage mask connector 108 (see FIG. 2). Pendant 214 also includes a rearward portion 304 that preferably includes provisions to connect to tube 210. Pendant 214 also includes a central portion 306 disposed between forward portion 302 and rearward portion 304. In the exemplary embodiment shown in FIG. 3, pendant 214 is generally cylindrical in shape with a tapered forward portion; however, pendant 214 can assume any desired shape or configuration.

In some embodiments, pendant 214 includes provisions to receive gas. These provisions can include a port. In the embodiment shown in FIG. 3, pendant 214 includes gas port 308. Gas port 308 can be disposed anywhere on pendant 214. FIG. 3 shows an example of a gas port 308 disposed on a central portion 306 of pendant 214. It is also possible to place a gas port 310 on rearward portion 304. It is also possible to include two or more gas ports in similar or different locations.

Regardless of the location or number of gas ports, each gas port is preferably designed to engage a suitable gas connector. The gas port is preferably in flow communication with the provisions that engage mask connector 108. Using this arrangement, the gas port can deliver gas to the user via mask connector 108 and mask tube 106 (see FIG. 2).

In some embodiments, the gas port is designed to receive and deliver oxygen. In other embodiments, the gas port can receive a gas infused with medical or pharmaceutical agents. These agents can be used to counter-act and remedy the effects of NBC toxins and substances. Using the gas port, oxygen, medicine and/or other gaseous products can be delivered to the user without the user having to remove CBE 100 (see FIG. 1). This allows the administration of gaseous products to the user in hostile NBC environments possible.

In some embodiments, the gas port is associated with a valve that interrupts or blocks the flow of fluid from tube 210 through pendant 214 and out of forward end 302. This valve can be automatically actuated when gas is delivered to the gas port.

FIGS. 4, 5 and 6 show a preferred embodiment of soft canteen 202. Referring to FIGS. 4, 5 and 6, soft canteen 202 includes an outer bag 402, an inner bag 404, and port body 406. Preferably, the contents of inner bag 404 are separated from outer bag 402 and a space is defined between outer bag 402 and inner bag 404. This space can be referred to as pressure space 408. In a preferred embodiment, inner bag 404 contains fluid and the interior portion of inner bag 404 defines fluid chamber 410. Also, in a preferred embodiment, inner bag 404 is contained within outer bag 402. In other words, outer bag 402 surrounds inner bag 404. In some embodiments, a seal 420 is disposed between inner bag 404 and outer bag 402. This seal 420 provides a joint between inner bag 404 and outer bag 402.

Outer bag 402 can be constructed in a variety of different ways, in the embodiment shown in FIGS. 4 to 6, outer bag 402 includes an upper heat sealed edge 412. Outer bag 402 also engages port body 406. Preferably, port body 406 is disposed proximate heat sealed edge 412. Port body 406 includes a fluid port 414 in flow communication with fluid chamber 410 and a pressure port 416 in fluid communication with pressure space 408. In some embodiments, an integral pressure line 418 is used to provide flow communication between pressure port 416 and pressure space 408.

In some embodiments, attachment device 208 engages port body 406. Preferably, attachment device 208 and port body 406 facilitate simple and rapid attachment and detachment from each other. In an exemplary embodiment, port body 406 can be designed like a medical type dual quick connect and disconnect system. In this exemplary embodiment, attachment device 208 can be designed to correspond to, and mate with port body 406 and can also be designed as a corresponding medical type dual quick connect and disconnect system.

Attachment device 208 can be connected to tube 210 and pressure line 420. In some embodiments, tube 210 and pressure line 420 are integral with attachment device 208 and in other embodiments, one or both of tube 210 and/or pressure line 420 is connected to attachment device by use of a connector. Attachment device 208 can also include a pressure relief button 422. This button is preferably associated with pressure port 416 and can be used to reduce the pressure in pressure space 408.

Given the arrangement disclosed above, soft canteen 202 operates in the following way. Referring to FIGS. 1-6, soft canteen 202 is preferably filled with a fluid that is held by fluid chamber 410. In some cases, this fluid is drinking water, in other cases, this fluid includes nutrients and/or medical or pharmaceutical compounds. In any case, this fluid is intended to be consumed by a user wearing CPE 100.

A fluid filled soft canteen 202 is attached to attachment device 208. By attaching soft canteen 202 to attachment device 208, fluid port 414 is associated with tube 210 and pressure port 416 is associated with pressure line 420. Soft canteen 202 can then be placed in carrier 204.

Users can apply pressure to pressure space 408. This can be done by using pressure device 230. Pressure device 230 can be any device that is capable of increasing the pressure of another device or volume. Some examples of a suitable pressure device 230 include a hand or bulb pump or a gas cartridge, for example, a CO₂ cartridge. Pressure device 230 can be attached to carrier 204 or in some other convenient location.

Using pressure device 230, a user can urge fluid out of fluid chamber 410, through fluid port 414 and through tube 210. This can be accomplished by using pressure device 230 to increase the pressure inside pressure space 408. When pressure device is actuated, either by pumping or by actuating a valve, pressurized gas moves from pressure device 230, through pressure tube 420, into pressure port 416 and ultimately into pressure space 408. In those embodiments that include an integral pressure line 418, pressurized gas will travel through internal pressurized line 418 from pressure port 416 to pressure space 408.

As additional pressurized gas is fed into pressure space 408, pressure space 408 begins to enlarge and increase in volume within outer bag 402. Preferably, outer bag 402 and inner bag 404 are made of a material that is generally non-expandable, while at the same time, remaining flexible over a broad expected temperature range. The material also withstands cleaning operations. Although any material meeting these general guidelines can be used, polyethylene and medical grade silicone are preferred.

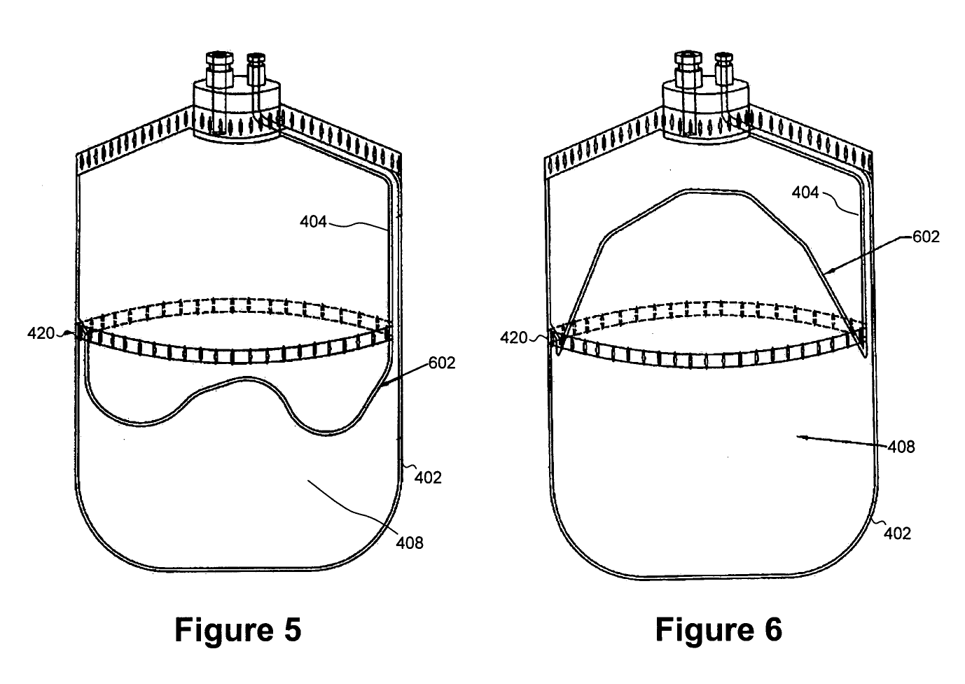

Because outer bag 402 is generally non-expandable, as pressure space 408 increases in volume due to the addition of pressurized gas, inner bag 404 experiences a reduction in volume, as shown in FIG. 5. This reduction in volume of inner bag 404 increases the pressure on the fluid contained in inner bag 404. This increase in pressure on that fluid tends to urge the fluid to exit fluid port 414 and move through tube 210. Eventually, when enough pressure is applied to pressure space 408, the fluid moves through pendant 214 and mask connector 108. Eventually, the fluid passes through mask tube 106 and finally is consumed by the user.

In some embodiments, a seal 420 is disposed between inner bag 404 and outer bag 402. This seal 420 helps to prevent inner bag 404 from collapsing and also helps inner bag 404 to drain properly. The function of seal 420 can be seen with reference to FIG. 6. As additional pressure is applied to pressure space 408, pressure space 408 continues to occupy additional volume inside outer bag 402 and inner bag 404 continues to occupy less space, as shown in FIG. 6. Because of seal 420, bottom portion 602 of inner bag 404 inverts and directs fluid towards fluid port 414. This helps to insure that fluid is efficiently evacuated and a neck or kink does not occur near fluid port 414. Without seal 420, the way inner bag 404 shrinks in volume would be difficult to predict or control. It is possible that inner bag 404 would first collapse near fluid port 414 and block the escape of fluid. Seal 420 helps to manage and control the way inner bag 404 collapses under pressure and to help insure the substantially complete and uninterrupted escape of fluid from inner bag 404.

Each of the various components, steps or features disclosed can be used alone or with other components, steps or features. Each of the components, steps or features can be considered discrete and independent building blocks. In some cases, combinations of the components, steps or features can be considered a discrete unit.

While various embodiments of the invention have been described, it will be apparent to those of ordinary skill in the art that may more embodiments and implementations are possible that are within the scope of the invention. Accordingly, the invention is not to be restricted except in light of the attached claims and their equivalents.

1. A system for transferring fluid into chemical protective equipment comprising:
a container comprising an outer bag and an inner bag, the inner bag containing a consumable fluid, and including a fluid port capable of transferring fluid from the inner bag;
a tube connected to the fluid port at a first end and connected to a pendant at a second end;
the pendant configured to engage a mask connector;
the outer bag substantially surrounding the inner bag;
a pressure space being defined between the outer bag and the inner bag;
the pressure space having a pressure port in flow communication with a pressure source, the pressure source capable of increasing a pressure in the pressure space; and wherein
increasing pressure in the pressure space causes fluid contained in the inner bag to flow out of the fluid port.

2. The system according to claim 1, wherein the container includes an integral pressure line that places the pressure space in fluid communication with the pressure port.

3. The system according to claim 1, wherein the container includes a seal between the inner bag and the outer bag.

4. The system according to claim 3, wherein the seal joins the inner bag to the outer bag.

5. The system according to claim 1, wherein the container includes a pressure release mechanism.

6. The system according to claim 1, wherein the fluid port and the pressure port include a dual quick disconnect assembly.

7. The system according to claim 1, wherein an increase in volume of the pressure space causes a decrease in volume of the inner bag.

8. A system for delivering a fluid and gas comprising:
a container including a fluid chamber and a pressure space;
the fluid chamber including a fluid port in flow communication with the fluid chamber;
a tube having a first end connected to the fluid port and a second end connected to a pendant;
the pendant having a first portion configured to engage a mask connector;
the pendant also having a gas port configured to receive gas.

9. The system according to claim 8, wherein the gas port is disposed on a central portion of the pendant.

10. The system according to claim 8, wherein the gas port is disposed on a rearward portion of the pendant, proximate the tube.

11. The system according to claim 8, wherein fluid is capable of passing through the pendant and the gas port interrupts fluid flow through the pendant.

12. The system according to claim 8, wherein the gas includes oxygen.

13. The system according to claim 8, wherein the gas includes a gas infused with a pharmaceutical compound.

14. The system according to claim 8, wherein the gas is delivered to a user through a mask connector and a mask tube.

15. A system for transferring fluid into chemical protective equipment comprising:
a container comprising an outer bag and an inner bag, the inner bag containing a consumable fluid, and including a fluid port capable of transferring fluid from the inner bag;
a tube connected to the fluid port at a first end and connected to a pendant at a second end;
the pendant configured to engage a mask connector and having a gas port configured to receive gas;
a pressure space being defined between an outer bag and the inner bag;
the pressure space having a pressure port in flow communication with a pressure source, and wherein
increasing pressure in the pressure space causes a reduction in volume of the inner bag.

16. The system according to claim 15, wherein fluid is capable of passing through the pendant and the gas port interrupts fluid flow through the pendant.

17. The system according to claim 15, wherein the container includes a seal between the inner bag and the outer bag.

18. The system according to claim 17, wherein the seal joins the inner bag to the outer bag.

19. The system according to claim 17, wherein the bottom portion of the inner bag becomes inverted as additional pressure is applied to the pressure space.

20. The system according to claim 19, wherein the container includes an integral pressure line that places the pressure space in fluid communication with the pressure port.
